(19) United States
(12) Patent Application Publication
(10) Pub. No.: US 2025/0157200 A1
(43) Pub. Date: May 15, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: KEI OCHIAI, Kanagawa (JP)

(21) Appl. No.: 18/944,982

(22) Filed: Nov. 12, 2024

(30) Foreign Application Priority Data
Nov. 14, 2023 (JP) 2023-193918

(51) Int. Cl. G06V 10/776; G06V 10/70; G06V 10/764; G06V 10/778

(52) U.S. Cl. CPC G06V 10/776; G06V 10/764; G06V 10/7796; G06V 10/87

(57) ABSTRACT

An information processing apparatus that executes active learning by repeating image selection and retraining of a learning model with the selected images includes an acquisition unit configured to acquire a trained learning model, a first selection unit configured to select an image transformation method executed on an image by using the acquired learning model, and a second selection unit configured to select an image used to retrain the learning model by using the selected image transformation method and the acquired learning model.

### BACKGROUND

### Field

The present disclosure relates to machine learning technology.

### Description of the Related Art

In recent years, computer vision (CV) tasks using machine learning techniques have been used in various situations. In particular, in a technique such as deep learning using a neural network, a better performance can be achieved by extracting knowledge or features from a large volume of data and by executing training. However, in the case of a machine learning model using deep learning, it is necessary to execute training by using a large volume of annotated data, and an enormous amount of work is needed to create the annotated data. For example, in the case of a segmentation task, annotated data is created for each target object captured in an image. In annotated data, a label indicating the classification of an individual object and the segmentation area of the individual object are indicated by pixels. Executing such work on a large volume of data needs much manpower and time, resulting in a large operating cost. Thus, it is desirable to generate a machine learning model having a better performance by executing training with a small volume of annotated data. As one method for achieving this end, active learning is known. Active learning is a method for generating a high-performance machine learning model with a reduced work cost. In active learning, by using the current machine learning model, data that could contribute to better performance improvement is selected from unannotated data, only the selected data is annotated, and training is executed. “Consistency-based Active Learning for Object Detection, arXiv 2021” discusses using an object detector that detects a certain object included in an image and using the uncertainty of the classification class of an object and the uncertainty of the location of the object, as data selection indices.

According to the technique discussed in “Consistency-based Active Learning for Object Detection, arXiv 2021”, at data selection, the uncertainties are calculated by executing data transformation such as geometrical transformation or noise addition. However, although there are various kinds of data transformation methods, a fixed data transformation method is executed. That is, the data transformation method to be executed will not be changed from the initially set data transformation method. For example, a case in which vertical inversion is set as the data transformation executed on image data and data selection and retraining are repeatedly executed will be considered. In this case, the current machine learning model could indicate a lower certainty about the inference result of image data on which noise addition has been executed than the certainty about the inference result of image data on which vertical inversion has been executed. In this case, it may be desirable to select the image data on which noise addition has been executed in terms of improvement in the performance of the machine learning model.

### SUMMARY

The present disclosure is directed to selecting an image that contributes to improvement in the performance of a learning model by using a suitable image transformation method.

According to an aspect of the present disclosure, an information processing apparatus that executes active learning by repeating image selection and retraining of a learning model with the selected images includes at least one memory storing a program, and at least one processor that, upon execution of the program is configured to operate as an acquisition unit configured to acquire a trained learning model, a first selection unit configured to select an image transformation method executed on an image by using the acquired learning model, and a second selection unit configured to select an image used to retrain the learning model by using the selected image transformation method and the acquired learning model.

Further features of the present disclosure will become apparent from the following description of exemplary embodiments with reference to the attached drawings.

### BRIEF DESCRIPTION OF THE DRAWINGS

FIG. 1 illustrates a hardware configuration example of an active learning system.

FIG. 2 illustrates a functional configuration example of the active learning system.

FIG. 3 is a flowchart illustrating a process of active learning according to first to third exemplary embodiments.

FIGS. 4A to 4D illustrate examples of images.

FIG. 5 illustrates the flow of an image transformation method selection process according to the first exemplary embodiment.

FIG. 6 illustrates the flow of an annotation addition target image selection process according to the first exemplary embodiment.

FIG. 7 illustrates the flow of an image uncertainty calculation process according to a second exemplary embodiment.

FIG. 8 illustrates the flow of an annotation addition target image selection process according to the second exemplary embodiment.

FIG. 9 illustrates the flow of an image uncertainty calculation process according to a third exemplary embodiment.

FIG. 10 illustrates the flow of an annotation addition target image selection process according to the third exemplary embodiment.

FIG. 11 is a flowchart illustrating a process of active learning according to a fourth exemplary embodiment.

### DESCRIPTION OF THE EMBODIMENTS

Hereinafter, suitable exemplary embodiments of the present disclosure will be described with reference to the attached drawings. The configurations in the following exemplary embodiments are only examples, and the present disclosure is not limited to these configurations.

An active learning system according to the present exemplary embodiment executes active learning by repeating image selection using the current learning model and retraining with selected images, so as to execute a computer vision (CV) task. Examples of the CV task include image classification, object detection, and segmentation. In the present exemplary embodiment, a case in which the active learning system is applied to a learning model for executing an image classification task will be described.

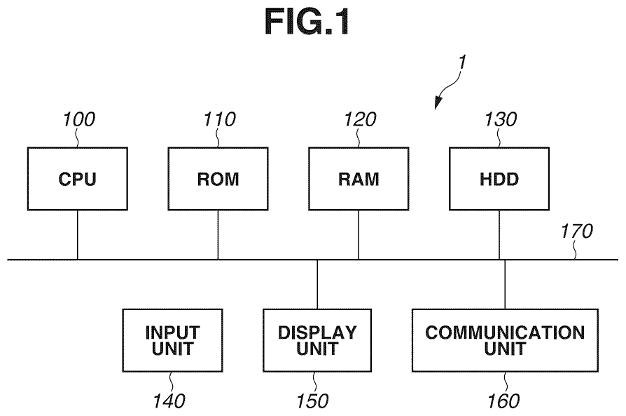

FIG. 1 illustrates a hardware configuration example of an active learning system 1. The active learning system 1 includes a central processing unit (CPU) 100, a read-only memory (ROM) 110, a random access memory (RAM) 120, a hard disk drive (HDD) 130, an input unit 140, a display unit 150, and a communication unit 160. These components are connected to each other via a bus 170. The CPU 100 executes operations for various kinds of processing. The CPU 100 comprehensively controls the active learning system 1. The CPU 100 realizes the processes in the flowcharts, which will be described below, by executing programs stored in the ROM 110, the HDD 130, etc. The ROM 110 stores a control program, and the RAM 120 is used as a main memory for the CPU 100 and as a temporary storage area such as a work area.

The HDD 130 stores image datasets, model parameters constituting a trained model, and various kinds of programs, for example. An external storage device may be used as an alternative to the HDD 130. The external storage device may be realized by, for example, a medium (a storage medium) and an external storage drive for realizing access to the medium. A flexible disk (FD), a compact disc (CD)-ROM, a digital versatile disc (DVD), a universal serial bus (USB) memory, a magneto-optical (MO) disc, and a flash memory are known as examples of the medium. In addition, the external storage device may be a server apparatus or the like connected to a network.

The input unit 140 includes a keyboard, a touch panel, etc., and receives input from a user. The display unit 150 includes a liquid crystal display, etc., and can display various kinds of data and processing results to the user. The communication unit 160 is a network interface for communicating with external apparatuses. The CPU 100 may receive an instruction from the user and may transmit a processing result to an external apparatus via the communication unit 160. The active learning system 1 may be configured by using a general-purpose information processing apparatus including the above components.

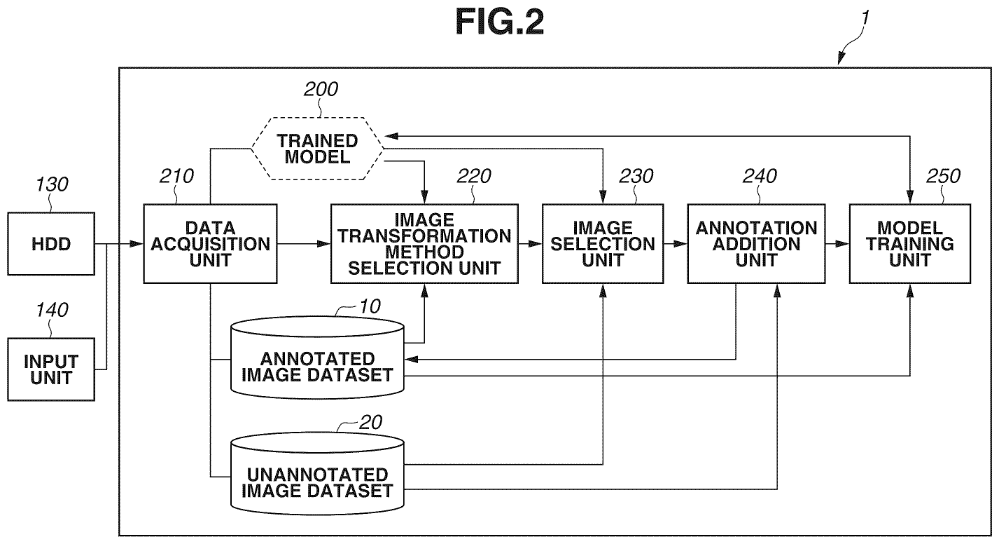

FIG. 2 illustrates a functional configuration example of the active learning system 1 according to the present exemplary embodiment. In the active learning system 1, the CPU 100 executes a program stored in the HDD 130 or the like, and functions as a data acquisition unit 210, an image transformation method selection unit 220, an image selection unit 230, an annotation addition unit 240, and a model training unit 250. In addition, an annotated image dataset 10, an unannotated image dataset 20, and a trained model 200 are stored in the HDD 130.

The data acquisition unit 210 acquires the annotated image dataset 10, the unannotated image dataset 20, and the trained model 200 from the HDD 130. If the data acquisition unit 210 cannot acquire the trained model 200, the model training unit 250 may generate the trained model 200 by using the annotated image dataset 10. The data acquisition unit 210 may acquire the annotated image dataset 10 and the unannotated image dataset 20 via the input unit 140 or the communication unit 160.

The image transformation method selection unit 220 selects an image transformation method used at image selection from the image transformation method candidates by using the trained model 200 and the annotated image dataset 10. Examples of the image transformation method include geometrical transformation, color tone transformation, noise addition, blurring, mosaic, and a combination of at least two of the above. The image transformation method selection unit 220 is an example of a first selection unit.

The image selection unit 230 uses the image transformation method selected by the image transformation method selection unit 220 and the trained model 200 as the current learning model, to select an image that is deemed to contribute to improvement in the performance of the trained model 200 from the unannotated image dataset 20. The image selection unit 230 is an example of a second selection unit.

The annotation addition unit 240 adds an annotation to the image selected by the image selection unit 230. The annotation includes ground truth information about the image.

The model training unit 250 retrains the trained model 200 by using the image, which has been selected by the image selection unit 230 and which includes the annotation added by the annotation addition unit 240.

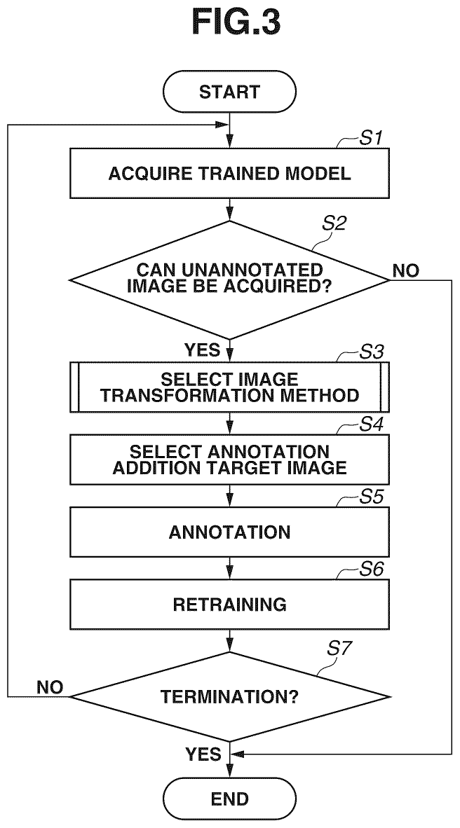

FIG. 3 is a flowchart illustrating a process of active learning according to the present exemplary embodiment.

The present exemplary embodiment describes an example in which the active learning system 1 is applied to an image classification task. The image classification means determining the classification class of an image or the classification class of a certain object included in an image. Herein, an example in which an image classifier classifies an individual image into “car” or “motorcycle” will be described.

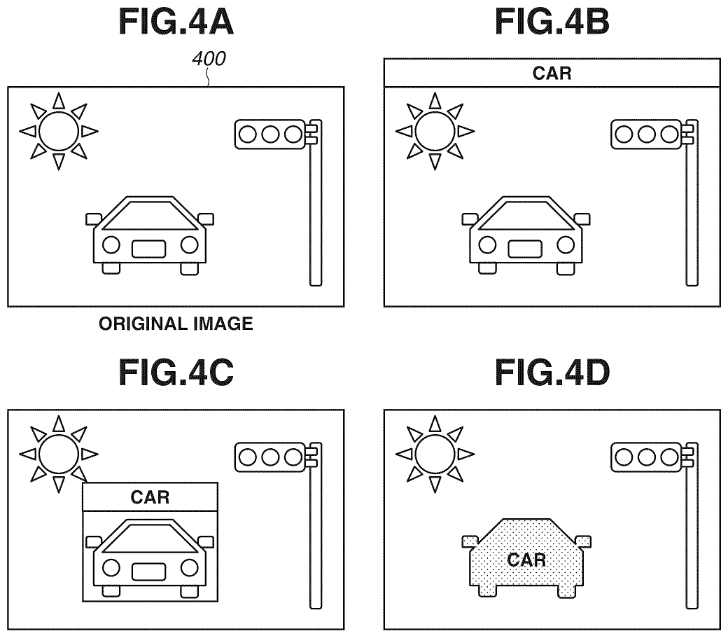

FIGS. 4A to 4D illustrate examples of annotated images.

An image 400 illustrated in FIG. 4A is an original image. In FIG. 4B, a classification class “car” as ground truth information in the image classification is added to the image 400. As illustrated in FIG. 4B, an image to which an annotation including ground truth information about this image is added will be referred to as an annotated image.

Hereinafter, the process flow (steps S1 to S6) of the active learning in FIG. 3 will be described. The process flow of the active learning will not be terminated until a termination condition in step S7 is satisfied.

In step S1, the data acquisition unit 210 acquires the trained model 200. In the present exemplary embodiment, the data acquisition unit 210 acquires a trained image classifier as the trained model 200. In the initial state, an image classifier may be trained by using a small volume of annotated image dataset, and the trained image classifier may be acquired as the trained model 200. Alternatively, a widely distributed trained image classifier may be acquired as the trained model 200. After the present flowchart is started, the data acquisition unit 210 acquires the current trained image classifier. That is, the data acquisition unit 210 acquires a trained image classifier, which has been retrained and updated in the previous S6.

In step S2, the data acquisition unit 210 determines whether an unannotated image can be acquired. Specifically, the data acquisition unit 210 determines, for example, whether there is an image in the unannotated image dataset 20 or there is an image that has been newly added to the unannotated image dataset 20. If the data acquisition unit 210 determines that an unannotated image cannot be acquired (NO in step S2), the data acquisition unit 210 determines that there is no new image that can be used for training, and therefore, the data acquisition unit 210 terminates the process of the present flowchart. If the data acquisition unit 210 determines that an unannotated image can be acquired (YES in step S2), the data acquisition unit 210 acquires the unannotated image dataset 20 and the annotated image dataset 10, and the process proceeds S3.

In step S3, the image transformation method selection unit 220 calculates a score for an individual image transformation method candidate by using the annotated image dataset 10 and the trained model 200 acquired in step S1, and selects an image transformation method based on the calculated scores.

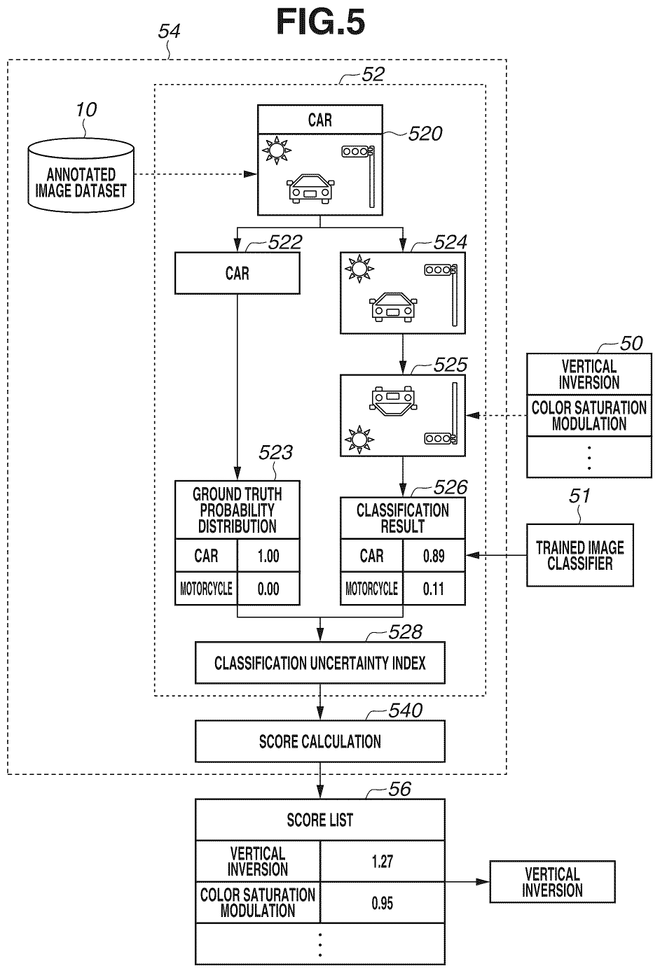

FIG. 5 schematically illustrates the content of an image transformation method selection process in step S3 according to the present exemplary embodiment. The image transformation method selection process in step S3 includes a score calculation process 54. In the score calculation process 54, the image transformation method selection unit 220 gives a score for an individual predefined image transformation method candidate 50 by using a trained image classifier 51. The image transformation method candidates 50 are, for example, geometrical transformation such as inversion and rotation, color tone transformation such as color saturation transformation and brightness transformation, noise addition, blurring, and mosaic. The trained image classifier 51 is an example of the trained model 200.

A score list 56 is a list of processing results of the score calculation process 54, and represents a score for each of the image transformation method candidates 50 (vertical inversion, color saturation modulation, etc.). The image transformation method selection unit 220 refers to the score list 56 and selects the image transformation methods whose score is in the top K or image transformation methods whose score is equal to or more than a threshold, as the important image transformation methods.

The score calculation process 54 includes a uncertainty calculation process 52. In the uncertainty calculation process 52, the image transformation method selection unit 220 enters a transformed image, which has been obtained by executing image transformation on an annotated image included in the annotated image dataset 10, to the trained image classifier 51, and calculates the uncertainty of the classification result obtained by the trained image classifier 51. In the score calculation process 54, the image transformation method selection unit 220 calculates a score for each of the image transformation method candidates 50, by using a corresponding classification uncertainty index 528 calculated in the uncertainty calculation process 52. The following description will be made based on an example in which a score is calculated for vertical inversion, which is executed on an annotated image 520 and which is one of the image transformation method candidates 50. The annotated image 520 includes ground truth information 522 included in the annotation, and includes an image 524. Herein, the ground truth information 522 represents “car”.

First, the image transformation method selection unit 220 executes vertical inversion on the image 524, to generate a transformed image 525. Next, the image transformation method selection unit 220 uses the trained image classifier 51, to classify the transformed image 525 and obtain a classification result 526. The classification result 526 is an example of the output result obtained by entering the transformed image 525 to the current trained model. Next, the classification result 526 is transformed into a probability distribution. For example, a softmax function may be used for the transformation into the probability distribution.

In this example, because the image classifier 51 classifies an individual image into “car” or “motorcycle”, the image transformation method selection unit 220 generates a ground truth probability distribution 523 in which the probability of “car” is 1 and the probability of “motorcycle” is 0 by using the ground truth information 522. In the present exemplary embodiment, although the image transformation method selection unit 220 generates the ground truth probability distribution 523 by using the ground truth information 522 added to the annotated image 520, the classification result 526 obtained by causing the trained image classifier 51 to classify the image, which has not yet been transformed (herein, the image 524), may be used as the ground truth information. That is, the classification uncertainty index may be calculated by using a small volume of unannotated image dataset.

Next, the image transformation method selection unit 220 uses the ground truth probability distribution 523 and the classification result 526 transformed to the probability distribution, to calculate the classification uncertainty index 528 of the trained image classifier 51 for the annotated image 520 on which vertical inversion has been executed. In the present exemplary embodiment, as the classification uncertainty index 528, the distance between the probability distributions is used. Specifically, the Jensen-Shannon distance is calculated. The distance calculation method is not limited to any particular method, as long as the distance between the probability distributions can be measured. For example, the Kullback-Leibler distance, the Pearson distance, the relative Pearson distance, or the L2-distance may be used. The comparison result between the ground truth information 522 and the classification result 526 is reflected on the distance calculated herein.

The image transformation method selection unit 220 calculates the classification uncertainty index 528 in the same way for each of the annotated images included in the annotated image dataset 10, integrates the classification uncertainty indices 528 of all the annotated images, and executes score calculation 540 for the image transformation method (herein, vertical inversion). For example, the score is calculated based on the following mathematical equation (1).

$$Score = \vert typical ( {U}_{{im}_{0}} , {U}_{{im}_{1}} , ... , {U}_{{im}_{n}} ) - β \vert \qquad ( 1 )$$

In equation (1), reference characters denote the following meanings.
Uᵢₘ: uncertainty
Uᵢₘₖ: uncertainty of annotated image with image number k
0, 1, . . . , n: image number of annotated image
β: constant

The image transformation method selection unit 220 uses the above mathematical equation (1), to calculate a typical value of the uncertainties (Uᵢₘ) of the individual annotated images, and obtains the L1 distance from an arbitrarily set reference point β. Regarding the calculation of the typical value, a numerical typical value such as an arithmetic mean or a geometric mean or a locational typical value such as a median or a mode is used. If the Jensen-Shannon distance is used for the calculation of the individual uncertainty, the uncertainty becomes higher as the typical value is closer to 1. If the reference point β is set to a value closer to 0, the score of an image transformation method whose uncertainty is high becomes higher. In contrast, if the reference point β is set to a value closer to 1, the score of an image transformation method whose uncertainty is high becomes lower. An image transformation method whose uncertainty is high can be considered to be image transformation that is difficult for the trained image classifier 51 to handle. The value of the reference point β is empirically determined based on the task.

The image transformation method selection unit 220 executes the score calculation 540 in the same way for each of the image transformation method candidates 50 and generates a score list 56, and selects the image transformation methods whose score is in the top K or the image transformation methods whose score is equal to or more than a score threshold. The value K and the score threshold may each be an arbitrary value, and may be determined empirically.

Referring back to FIG. 3, in step S4, the image selection unit 230 selects, as an annotation addition target, an unannotated image deemed to contribute to performance improvement from the unannotated image dataset 20 by using the image transformation method selected in step S3 and the trained model 200 acquired in step S1.

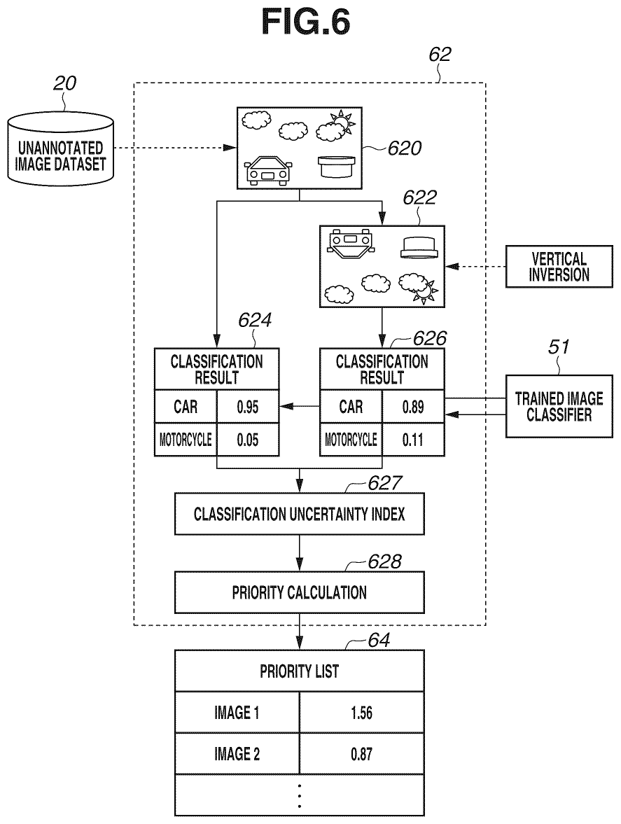

FIG. 6 schematically illustrates the content of an annotation addition target image selection process in step S4 according to the present exemplary embodiment. The annotation addition target image selection process in step S4 includes a priority calculation process 62. In the priority calculation process 62, the image selection unit 230 prioritizes the unannotated images in the unannotated image dataset 20 by using the trained image classifier 51. A priority list 64 is a list of processing results of the priority calculation process 62, and represents the priorities of the unannotated images (image 1, image 2, etc.) in the unannotated image dataset 20. The image selection unit 230 refers to the priority list 64, and selects the images whose priority is in the top N or images whose priority is equal to or more than a threshold, as the important images. Hereinafter, the priority calculation will be described based on an example in which vertical inversion is selected as the image transformation method.

First, the image selection unit 230 classifies an unannotated image 620 by using the trained image classifier 51, and obtains a classification result 624. Next, the image selection unit 230 transforms the classification result 624 into a probability distribution. Next, the image selection unit 230 executes vertical inversion on the unannotated image 620, to generate a transformed image 622. Next, the image selection unit 230 uses the trained image classifier 51 to classify the transformed image 622, and obtains a classification result 626. Next, the image selection unit 230 transforms the classification result 626 into a probability distribution. Next, by using the classification result 624 transformed into the probability distribution and the classification result 626 transformed into the probability distribution, the image selection unit 230 calculates a classification uncertainty index 627 of the trained image classifier 51 for the unannotated image 620 on which vertical inversion has been executed. Herein, the method for calculating the classification uncertainty index 627 is similar to the method for calculating the classification uncertainty index 528 in FIG. 5.

Next, the image selection unit 230 executes priority calculation 628 for the image by using the calculated classification uncertainty index 627. For example, the priority is expressed by the following mathematical equation (2).

$$Priority = \vert {U}_{im} - β \vert \qquad ( 2 )$$

In equation (2), reference characters denote the following meanings.
Uᵢₘ: uncertainty
β: constant

The image selection unit 230 calculates the L1 distance from an arbitrarily set reference point β by using the uncertainty (Uim) of the unannotated image and the above equation (2). If the reference point β is set to a value closer to 0, the priority of an image whose certainty of the trained image classifier 51 is poor becomes high. An image with a high uncertainty can be considered to be a difficult image for the trained image classifier 51 to handle.

The image selection unit 230 executes the priority calculation 628 for each of the unannotated images included in the unannotated image dataset 20, generates the priority list 64, and selects, as the annotation addition targets, the images whose priority is in the top N or the images whose priority is equal to or more than a priority threshold. The value N and the priority threshold may each be an arbitrary value.

Referring back to FIG. 3, in step S5, the annotation addition unit 240 annotates the unannotated image selected in step S4. For this annotation, the display unit 150 and the input unit 140 may be used. The annotation addition unit 240 adds the image annotated in step S5 to the annotated image dataset 10, to update the annotated image dataset 10.

In step S6, the model training unit 250 retrains the trained model 200 acquired in step S1 by using the annotated image dataset 10 updated in step S5. The model training unit 250 updates the trained model 200, on which the retraining has been executed, as a new trained model 200.

In step S7, the CPU 100 determines whether a training termination condition is satisfied. For example, the model training unit 250 may determine whether a desired accuracy has been obtained for the retrained model 200, and may use the determination result as the training termination condition. Alternatively, the CPU 100 may determine whether the priority list 64 includes an image whose priority is equal to or more than the priority threshold, and may use the determination result as the training termination condition.

If the CPU 100 determines that the training termination condition has not been satisfied yet (NO in step S7), for example, if a desired accuracy has not been obtained yet, the process returns to S1, and the current trained model 200 (the trained model 200 on which the retraining has been executed) is acquired. That is, the CPU 100 continuously executes the process flow (steps S1 to S6) of the active learning until the learning termination condition is satisfied. If the CPU 100 determines that the training termination condition has been satisfied (YES in step S7), the CPU 100 terminates the process of the present flowchart.

According to the present exemplary embodiment, in the process of executing active learning on a learning model for executing an image classification task, an image transformation method used when an image that contributes to improvement in the performance of the current trained model is selected can be dynamically selected by using the current trained model. That is, it is possible to select an image that contributes to improvement in the performance of a trained model by using a suitable image transformation method.

The present exemplary embodiment will be described based on an example in which the active learning system 1 is applied to an object detection task. The object detection means determining the location of a certain object included in an image and determining the classification class of the object. Herein, an example in which an object detector detects “car” or “motorcycle” from an image will be described. Hereinafter, the description of elements similar to those according to the first exemplary embodiment will be omitted. That is, the following description will be made with a focus on the elements that are different from those according to the first exemplary embodiment.

In FIG. 4C, a boundary frame indicating the location of a car and “car” of the classification class as the ground truth information of the object detection are added to the image 400.

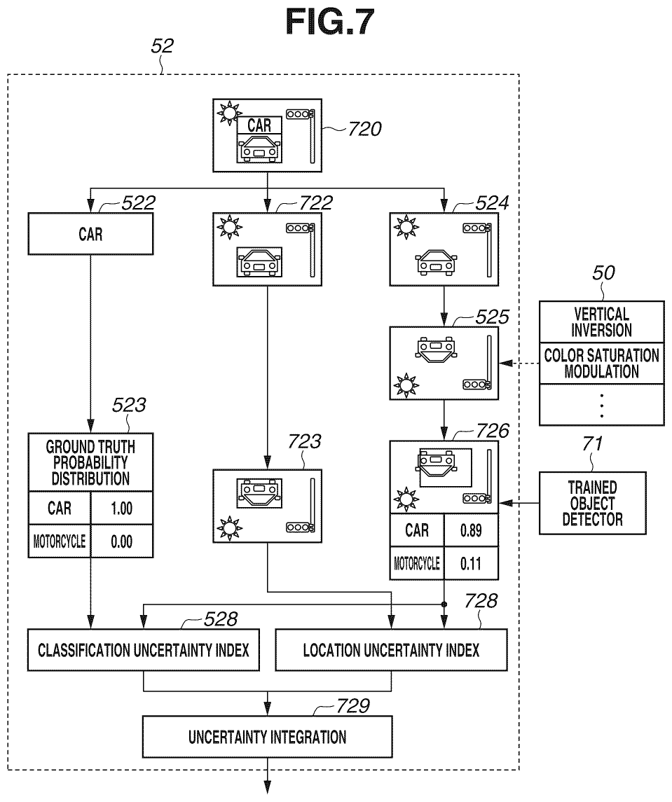

In the present exemplary embodiment as well, the flowchart illustrated in FIG. 3 is applied. FIG. 7 schematically illustrates an uncertainty calculation process 52 in an image transformation method selection process in step S3 according to the present exemplary embodiment. In the uncertainty calculation process 52, the image transformation method selection unit 220 enters an transformed image, which has been obtained by executing image transformation on an annotated image included in the annotated image dataset 10, to a trained object detector 71, and calculates the uncertainty of the detection result obtained by the trained object detector 71. The trained object detector 71 is an example of the trained model 200. The following description will be made based on an example in which an uncertainty is calculated for vertical inversion, which is executed on an annotated image 720 and which is one of the image transformation method candidates 50. The annotated image 720 includes ground truth information 522 included in the annotation, location ground truth information 722, and an image 524. The ground truth information 522 and the image 524 are similar to those in FIG. 5.

First, the image transformation method selection unit 220 executes vertical inversion on the image 524, to generate a transformed image 525. Next, the image transformation method selection unit 220 uses the trained object detector 71, to detect an object included in the transformed image 525 and obtain a detection result 726. Next, the image transformation method selection unit 220 executes vertical inversion on the location ground truth information 722 and generates transformed location ground truth information 723.

Next, the image transformation method selection unit 220 uses a ground truth probability distribution 523 and the classification probability distribution of the detection result 726, to calculate a classification uncertainty index 528 of the trained object detector 71 for the annotated image 720 on which vertical inversion has been executed. The classification uncertainty index 528 is similar to that in FIG. 5.

Next, the image transformation method selection unit 220 calculates a location uncertainty index 728 of the trained object detector 71 for the annotated image 720 on which vertical inversion has been executed, by using the transformed location ground truth information 723 and the location information of the detection result 726.

In the present exemplary embodiment, as the location uncertainty index 728, Intersection over Union (IoU) is used. IoU is calculated for an area A indicating the location of an object in an image and an area B in accordance with the following mathematical equation (3), for example.

$$IoU = ( A ⋂ B ) / ( A ⋃ B ) \qquad ( 3 )$$

As expressed by the above mathematical equation (3), IoU is obtained by dividing the shared portion of the two areas (the areas A and B) by the union, and is an index that represents the degree of overlapping of the two areas (the areas A and B). When the value of the IoU is closer to 0, the overlapping area is smaller, and the location uncertainty is higher. As the location uncertainty index 728, an index different from IoU may be used, as long as the index represents the degree of overlapping of location information.

Next, the image transformation method selection unit 220 executes uncertainty integration 729 by combining the classification uncertainty index 528 and the location uncertainty index 728. For this uncertainty integration 729, both or one of the classification uncertainty index 528 and the location uncertainty index 728 may be used. If the Jensen-Shannon distance is used for the classification uncertainty index 528 (Uᵢₘ^{class}) and if IOU is used for the location uncertainty index 728 (Uᵢₘ^{local}), the uncertainty (Uᵢₘ) of the image is expressed by the following mathematical equation (4).

$${U}_{im} = {U}_{im}^{class} + ( 1 - {U}_{im}^{local} ) \qquad ( 4 )$$

In the above mathematical equation (4), when the classification uncertainty index 528 (Uᵢₘ^{class}) is closer to 1, the uncertainty becomes higher. In addition, when the location uncertainty index 728 (Uᵢₘ^{local}) is closer to 0, the uncertainty becomes higher. Thus, the correlation about the sign is unified between the uncertainties. The image transformation method selection unit 220 executes the uncertainty integration 729 for the individual annotated images included in the annotated image dataset 10, integrates the uncertainties of all the annotated images, and calculates a score for the image transformation method (herein, vertical inversion). The image transformation method selection unit 220 calculates a score in the same way for each of the image transformation method candidates 50, and selects the image transformation methods whose score is in the top K or the image transformation methods whose score is equal to or more than a score threshold.

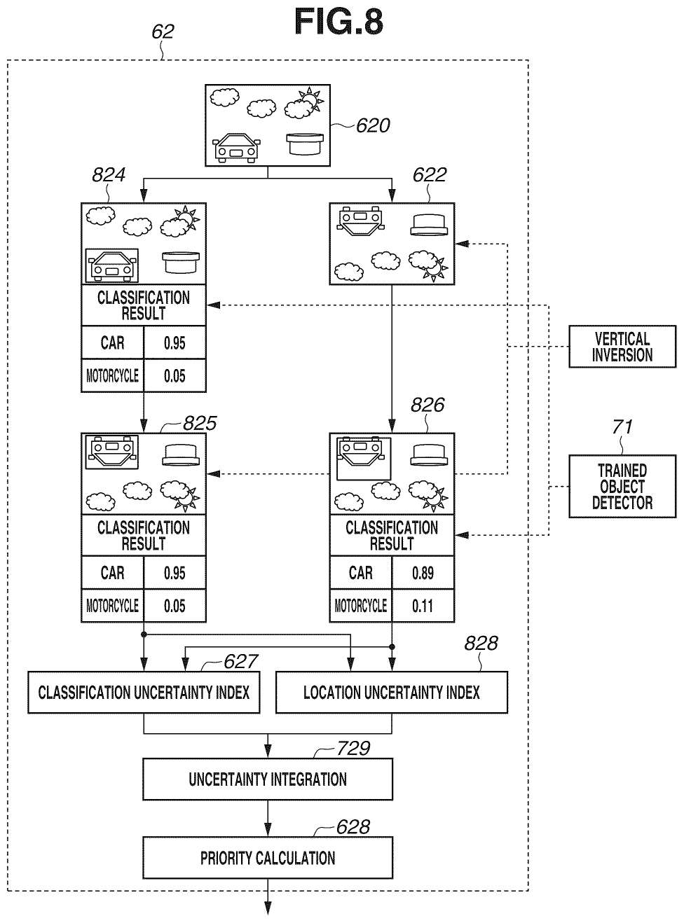

FIG. 8 schematically illustrates the content of an annotation addition target image selection process in step S4 according to the present exemplary embodiment. The annotation addition target image selection process in step S4 includes a priority calculation process 62. In the priority calculation process 62, the image selection unit 230 prioritizes the unannotated images in the unannotated image dataset 20 by using the trained object detector 71. Hereinafter, the priority calculation will be described based on an example in which vertical inversion is selected as the image transformation method.

First, the image selection unit 230 detects an object included in an unannotated image 620 by using the trained object detector 71, and obtains a detection result 824. Next, the image selection unit 230 executes vertical inversion on the detection result 824, to obtain a transformed detection result 825. Next, the image selection unit 230 executes vertical inversion on the unannotated image 620, to generate a transformed image 622. Next, the image selection unit 230 detects an object included in the transformed image 622 by using the trained object detector 71, to obtain a detection result 826 of the transformed image.

Next, by using the classification probability distribution of the transformed detection result 825 and the classification probability distribution of the detection result 826 of the transformed image, the image selection unit 230 calculates a classification uncertainty index 627 of the trained object detector 71 for the unannotated image 620 on which vertical inversion has been executed. Similarly, by using the location information about the transformed detection result 825 and the location information about the detection result 826 of the transformed image, the image selection unit 230 calculates a location uncertainty index 828 of the trained object detector 71 for the unannotated image 620 on which vertical inversion has been executed. Herein, the method for calculating the location uncertainty index 828 is similar to the method for calculating the location uncertainty index 728 in FIG. 7.

The image selection unit 230 executes uncertainty integration 729 by combining the classification uncertainty index 627 and the location uncertainty index 828. Next, by using a value obtained by the uncertainty integration 729, the image selection unit 230 executes priority calculation 628 for the individual unannotated image included in the unannotated image dataset 20.

According to the present exemplary embodiment, in the process of executing active learning on a learning model for executing an object detection task, an image transformation method used when an image that contributes to improvement in the performance of the current trained model is selected can be dynamically selected by using the current trained model. That is, it is possible to select an image that contributes to improvement in the performance of a trained model by using a suitable image transformation method.

The present exemplary embodiment will be described based on an example in which the active learning system 1 is applied to a segmentation task. The segmentation means determining the segmentation area of a certain object included in an image and determining the classification class of the object. Herein, an example in which a segmenter segments the area of “car” or “motorcycle” from an image will be described. Hereinafter, the description of elements similar to those according to the first exemplary embodiment will be omitted. That is, the following description will be made with a focus on the elements that are different from those according to the first exemplary embodiment.

In FIG. 4D, the area of a car and “car” of the classification class as the ground truth information of the segmentation area are added to the image 400.

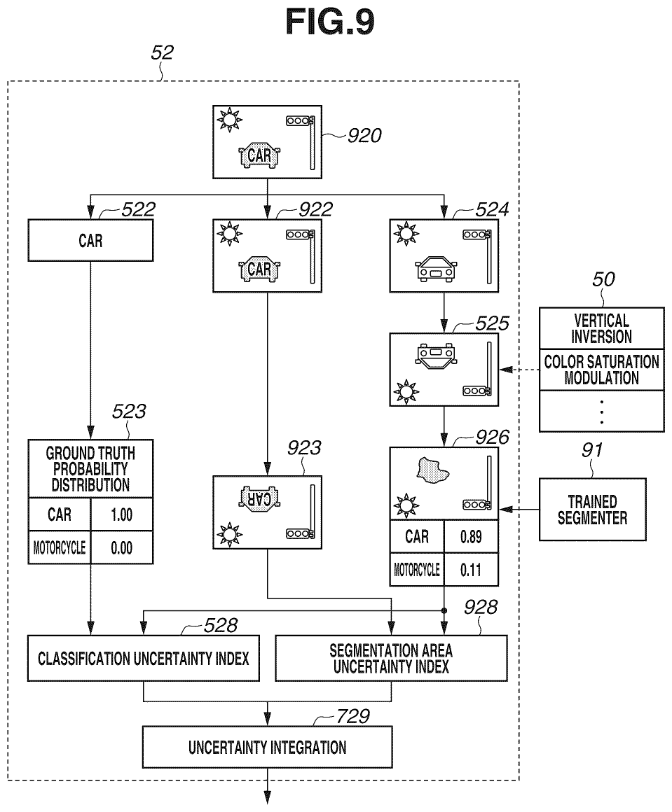

In the present exemplary embodiment as well, the flowchart illustrated in FIG. 3 is applied. FIG. 9 schematically illustrates an uncertainty calculation process 52 in an image transformation method selection process in step S3 according to the present exemplary embodiment. In the uncertainty calculation process 52, the image transformation method selection unit 220 enters a transformed image, which has been obtained by executing image transformation on an annotated image included in the annotated image dataset 10, to a trained segmenter 91, and calculates the uncertainty of the segmentation result obtained by the trained segmenter 91. The trained segmenter 91 is an example of the trained model 200. The following description will be made based on an example in which an uncertainty is calculated for vertical inversion, which is executed on an annotated image 920 and which is one of the image transformation method candidates 50. The annotated image 920 includes classification ground truth information 522 included in the annotation, segmentation area ground truth information 922, and an image 524. The ground truth information 522 and the image 524 are similar to those in FIG. 5.

First, the image transformation method selection unit 220 executes vertical inversion on the image 524, to generate a transformed image 525. Next, the image transformation method selection unit 220 uses the trained segmenter 91, to segment the area of an object included in the transformed image 525 and obtain a segmentation result 926. Next, the image transformation method selection unit 220 executes vertical inversion on the segmentation area ground truth information 922 and generates transformed segmentation area ground truth information 923.

Next, the image transformation method selection unit 220 uses a ground truth probability distribution 523 and the classification probability distribution of the segmentation result 926, to calculate a classification uncertainty index 528 of the trained segmenter 91 for the annotated image 920 on which vertical inversion has been executed. The classification uncertainty index 528 is similar to that in FIG. 5.

Next, the image transformation method selection unit 220 calculates a segmentation area uncertainty index 928 of the trained segmenter 91 for the annotated image 920 on which vertical inversion has been executed, by using the transformed segmentation area ground truth information 923 and the segmentation area information of the segmentation result 926. Herein, IoU is used as the segmentation area uncertainty index 928. That is, the image transformation method selection unit 220 may calculate the segmentation area uncertainty index 928 in the same way as used for the location uncertainty index 728 in FIG. 7. The image transformation method selection unit 220 executes the uncertainty integration 729 in the same way as in FIG. 7 on the individual annotated images included in the annotated image dataset 10 and integrates the uncertainties of all the annotated images, to calculate a score for the image transformation method (herein, vertical inversion). In addition, the image transformation method selection unit 220 calculates a score in the same way for each of the image transformation method candidates 50, and selects the image transformation methods whose score is in the top K or the image transformation methods whose score is equal to or more than a score threshold.

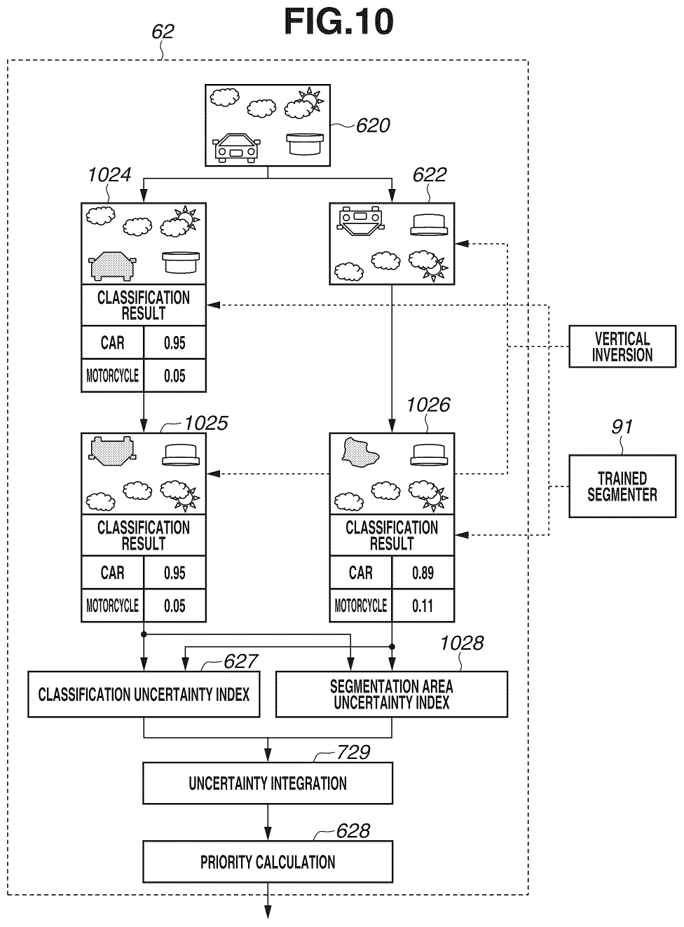

FIG. 10 schematically illustrates the content of an annotation addition target image selection process in step S4 according to the present exemplary embodiment. The annotation addition target image selection process in step S4 includes a priority calculation process 62. In the priority calculation process 62, the image selection unit 230 prioritizes the unannotated images in the unannotated image dataset 20 by using the trained segmenter 91. Hereinafter, the priority calculation will be described based on an example in which vertical inversion is selected as the image transformation method.

First, the image selection unit 230 uses the trained segmenter 91, to segment the segmentation area of an object included in an unannotated image 620 and obtain a segmentation result 1024. Next, the image selection unit 230 executes vertical inversion on the segmentation area information of the segmentation result 1024, to obtain a transformed segmentation result 1025. Next, the image selection unit 230 executes vertical inversion on the unannotated image 620, to generate a transformed image 622. Next, the image selection unit 230 uses the trained segmenter 91, to segment the area of an object included in the transformed image 622 and obtain a segmentation result 1026 of the transformed image.

Next, by using the classification probability distribution included in the transformed segmentation result 1025 and the classification probability distribution of the segmentation result 1026 of the transformed image, the image selection unit 230 calculates a classification uncertainty index 627 of the trained segmenter 91 for the unannotated image 620 on which vertical inversion has been executed. Similarly, by using the segmentation area information of the transformed segmentation result 1025 and the segmentation area information of the segmentation result 1026 of the transformed image, the image selection unit 230 calculates an segmentation area uncertainty index 1028 of the trained segmenter 91 for the unannotated image 620 on which vertical inversion has been executed. Herein, the method for calculating the segmentation area uncertainty index 1028 is similar to the method for calculating the area uncertainty index 928 in FIG. 9.

The image selection unit 230 executes uncertainty integration 729 by combining the classification uncertainty index 627 and the segmentation area uncertainty index 1028. Next, by using a value obtained by the uncertainty integration 729, the image selection unit 230 executes priority calculation 628 for the individual unannotated image included in the unannotated image dataset 20.

According to the present exemplary embodiment, in the process of executing active learning on a learning model for executing a segmentation task, an image transformation method used when an image that contributes to improvement in the performance of the current trained model is selected can be dynamically selected by using the current trained model. That is, it is possible to select an image that contributes to improvement in the performance of a trained model by using a suitable image transformation method.

The present exemplary embodiment describes a method for changing the currently set image transformation method when a change condition of the image transformation method is satisfied in the process of active learning. Hereinafter, the description of elements similar to those according to the first exemplary embodiment will be omitted. That is, the following description will be made with a focus on the elements that are different from those according to the first exemplary embodiment.

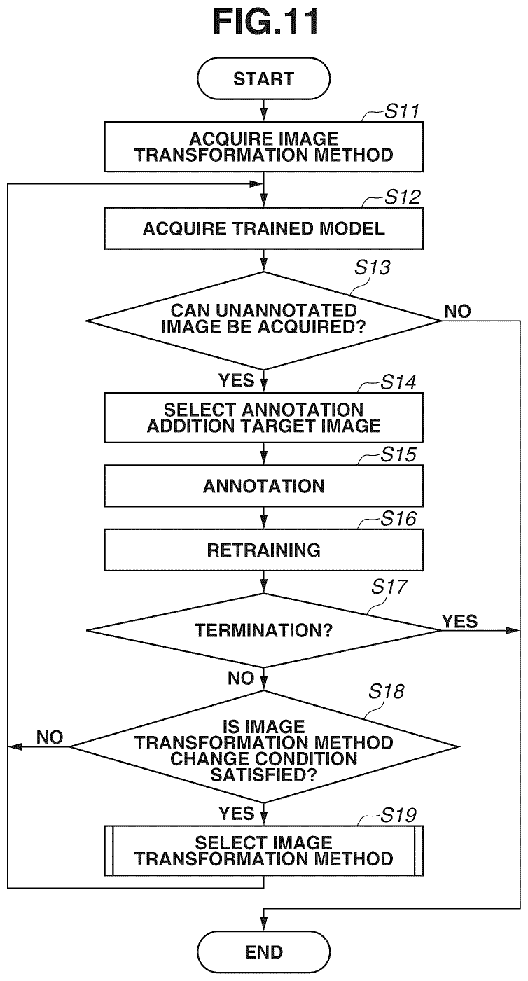

FIG. 11 is a flowchart illustrating a process of active learning according to the present exemplary embodiment. Steps S12 to S16 in FIG. 11 are continuously executed until the CPU 100 determines that a termination condition is satisfied in step S17.

In step S11, the data acquisition unit 210 acquires the currently set image transformation method. In the initial state, a default image transformation method may be acquired as the image transformation method. Alternatively, an image transformation method that the user has set with the input unit 140 may be acquired as the image transformation method. The currently set image transformation method is stored in the ROM 120 or the like.

In step S12, the data acquisition unit 210 acquires the trained model 200. In the present exemplary embodiment, the data acquisition unit 210 acquires a trained model suitable for the task. In the initial state, a model may be trained with a small volume of annotated image dataset and this trained model may be acquired. Alternatively, a widely distributed trained model may be acquired. After the present flowchart is started, the data acquisition unit 210 acquires the current trained model. That is, the data acquisition unit 210 acquires the trained model retrained and updated in the previous step S16.

In step S13, the data acquisition unit 210 determines whether an unannotated image can be acquired. This step is similar to step S2. If the data acquisition unit 210 determines that an unannotated image cannot be acquired (NO in step S13), the data acquisition unit 210 determines that there is no new image that can be used for training, and therefore, the data acquisition unit 210 terminates the process of the present flowchart. If the data acquisition unit 210 determines that an unannotated image can be acquired (YES in step S13), the data acquisition unit 210 acquires the unannotated image dataset 20 and the annotated image dataset 10, and the process proceeds to S14.

In step S14, the image selection unit 230 uses the currently set image transformation method and the trained model 200 acquired in step S12, to select an unannotated image that is deemed to contribute to performance improvement as an annotation addition target from the unannotated image dataset 20. In this step, the image selection unit 230 reads out the currently set image transformation method from the ROM 120 or the like. The annotation addition target image selection process in this step is similar to that described in FIGS. 6, 8, and 10.

In step S15, the annotation addition unit 240 annotates the unannotated image selected in step S14. This step is similar to step S5. The annotation addition unit 240 adds the image annotated in step S15 to the annotated image dataset 10, to update the annotated image dataset 10.

In step S16, the model training unit 250 retrains the trained model 200 acquired in step S12 by using the annotated image dataset 10 updated in step S15. The model training unit 250 updates the retrained model 200 as a new trained model 200.

In step S17, the CPU 100 determines whether a training termination condition is satisfied. This step is similar to step S7. If the CPU 100 determines that the training termination condition is not satisfied (NO in step S17), the process proceeds to S18. If the CPU 100 determines that the training termination condition is satisfied (YES in step S17), the CPU 100 terminates the process of the present flowchart.

In step S18, the CPU 100 determines whether an image transformation method change condition is satisfied. Herein, for example, the model training unit 250 may determine whether the cumulative number of images that have been used for retraining has exceeded a predetermined number, and may use the determination result as the image transformation method change condition. Alternatively, the model training unit 250 may determine whether an index indicating the proficiency of the current trained model 200 (retrained model 200) has exceeded a proficiency threshold, and may use the determination result as the image transformation method change condition. The image transformation method change condition is not limited to any particular condition, as long as the condition is about the progress of the training of the trained model 200 in the process of the active learning. In addition, a plurality of image transformation method change conditions is set depending on the stage of the progress of the training of the trained model 200. For example, a plurality of proficiency thresholds is set. If the CPU 100 determines that the image transformation method change condition is not satisfied (NO in step S18), the process returns to step S12, and the data acquisition unit 210 acquires the current trained model 200 (retrained model 200). If the CPU 100 determines that the image transformation method change condition is satisfied (YES in step S18), the process proceeds to S19.

In step S19, the image transformation method selection unit 220 uses the annotated image dataset 10 and the current trained model 200 (retained model 200), to calculate a score for each of the image transformation method candidates. Next, the image transformation method selection unit 220 selects an image transformation method based on the calculated scores. The image transformation method selection process in this step is similar to that described with reference to FIGS. 5, 7, and 9. The image transformation method selection unit 220 updates the currently set image transformation method stored in the ROM 120 or the like with the selected image transformation method. Next, the process returns to step S12.

According to the present exemplary embodiment, the image transformation method can be changed in stages, depending on the stage of the progress of the training of the trained model in the process of the active learning on the trained model. That is, it is possible to select an image that contributes to improvement in the performance of the trained model by using a suitable image transformation method.

Although the above-described exemplary embodiments have thus been described in detail, the present disclosure may be embodied as, for example, a system, an apparatus, a method, a program, a recording medium (a storage medium), etc. Specifically, the present disclosure may be applied to a system constituted by a plurality of apparatuses (for example, a host computer, an interface device, an imaging device, a Web application, etc.) or may be applied to a single device.

In addition, the exemplary embodiments have been described only as specific examples to carry out the present disclosure, and it shall not be interpreted that the technical range of the present disclosure is limited by the description of these exemplary embodiments. That is, the present disclosure can be carried out in various forms, without departing from its technological concept or its main features.

The present disclosure can be embodied by supplying a program that realizes at least one function of the above-described exemplary embodiments to a system or an apparatus via a network or a storage medium and by causing at least one processor in a computer in the system or the apparatus to read out and execute the program. The present disclosure can also be embodied by a circuit (for example, an application specific integrated circuit (ASIC)) that realizes at least one of the functions.

The disclosure of each of the above-described exemplary embodiments includes the following configurations, method, and storage medium.

### (Configuration 1)

An information processing apparatus that executes active learning by repeating image selection and retraining of a learning model with selected images includes an acquisition unit configured to acquire a trained learning model, a first selection unit configured to select an image transformation method executed on an image by using the learning model acquired by the acquisition unit, and a second selection unit configured to select, by using the image transformation method selected by the first selection unit and the learning model acquired by the acquisition unit, an image used to retrain the learning model.

### (Configuration 2)

There is provided the information processing apparatus according to configuration 1, wherein the first selection unit calculates a score for an individual image transformation method candidate by using an annotated image to which an annotation including ground truth information is added and the learning model acquired by the acquisition unit, and selects an image transformation method based on the score.

### (Configuration 3)

There is provided the information processing apparatus according to configuration 2, wherein the first selection unit includes a first calculation unit configured to enter a transformed image of the annotated image, the transformed image having been obtained by executing image transformation based on an image transformation method candidate, to the learning model acquired by the acquisition unit and configured to calculate an uncertainty of an output result obtained by the learning model, and wherein the first selection unit includes a second calculation unit configured to calculate the score for an individual image transformation method candidate based on an uncertainty calculated by the first calculation unit.

### (Configuration 4)

There is provided the information processing apparatus according to configuration 3, wherein the first calculation unit calculates the uncertainty by comparing the output result and the ground truth information.

### (Configuration 5)

There is provided the information processing apparatus according to any one of configurations 2 to 4, wherein the first selection unit selects an image transformation method whose score is high or is equal to or more than a threshold.

### (Configuration 6)

There is provided the information processing apparatus according to any one of configurations 1 to 5, wherein the second selection unit selects an image from unannotated images to which an annotation including ground truth information is not added, and the image selected by the second selection unit is used as an annotation addition target.

### (Configuration 7)

There is provided the information processing apparatus according to configuration 6, wherein the second selection unit includes a third calculation unit configured to enter a transformed image of the unannotated image, the transformed image having been obtained by executing image transformation based on an image transformation method selected by the first selection unit, to the learning model acquired by the acquisition unit and configured to calculate an uncertainty of an output result obtained by the learning model, and wherein the second selection unit includes a fourth calculation unit configured to calculate a priority of the unannotated image based on the uncertainty calculated by the third calculation unit.

### (Configuration 8)

There is provided the information processing apparatus according to any one of configurations 1 to 7, wherein the learning model is used to execute a task including at least one of image classification, object detection, and segmentation.

### (Configuration 9)

There is provided the information processing apparatus according to configuration 3, wherein in a case where the output result includes a classification result, the first calculation unit calculates the uncertainty based on a probability distribution distance between a probability distribution obtained from the ground truth information and the classification result transformed into a probability distribution.

### (Configuration 10)

There is provided the information processing apparatus according to configuration 3, wherein in a case where the output result includes location information or area information, the first calculation unit calculates the uncertainty based on a degree of overlapping between a location or an area obtained from the ground truth information and a location or an area included in the output result.

### (Configuration 11)

There is provided the information processing apparatus according to configuration 3, 9, or 10, wherein in a case where the output result includes both a classification result and location or area information, the second calculation unit calculates the score based on a combination of the uncertainty calculated based on the classification result and the uncertainty calculated based on the location or area or based on one of the uncertainties.

### (Configuration 12)

There is provided the information processing apparatus according to any one of configurations 1 to 11, wherein the first selection unit selects an image transformation method from candidates including at least one of geometrical transformation, color tone transformation, noise addition, blurring, and mosaic.

### (Configuration 13)

There is provided the information processing apparatus according to any one of configurations 1 to 12, further comprising an update unit configured to update the learning model by retraining the learning model acquired by the acquisition unit by using the image selected by the second selection unit, wherein the acquisition unit acquires the learning model updated by the update unit.

### (Configuration 14)

An information processing apparatus that executes active learning by repeating image selection and retraining of a learning model with selected images includes a setting unit configured to set an image transformation method for an image, an acquisition unit configured to acquire a trained learning model, and a selection unit configured to select, by using the image transformation method set by the setting unit and the learning model acquired by the acquisition unit, an image used to retrain the learning model, wherein the setting unit changes a currently set image transformation method, depending on progress of training of the learning model acquired by the acquisition unit.

### (Method)

An information processing method that executes active learning by repeating image selection and retraining of a learning model with selected images includes acquiring a trained learning model, executing first selection for selecting an image transformation method executed on an image by using the learning model acquired by the acquisition, and executing second selection for selecting, by using the image transformation method selected by the first selection and the learning model acquired by the acquisition, an image used to retrain the learning model.

### (Storage Medium)

A storage medium configured to store a program causing a computer of an information processing apparatus that executes active learning by repeating image selection and retraining of a learning model with selected images to function as an acquisition unit configured to acquire a trained learning model, a first selection unit configured to select an image transformation method executed on an image by using the learning model acquired by the acquisition unit, and a second selection unit configured to select, by using the image transformation method selected by the first selection unit and the learning model acquired by the acquisition unit, an image used to retrain the learning model.

According to the present disclosure, an image that contributes to improvement in the performance of a learning model can be selected by using a suitable image transformation method.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-193918, filed Nov. 14, 2023, which is hereby incorporated by reference herein in its entirety.

What is claimed is:

1. An information processing apparatus that executes active learning by repeating image selection and retraining of a learning model with the selected images, the information processing apparatus comprising:
at least one memory storing a program; and
at least one processor that, upon execution of the program is configured to operate as:
an acquisition unit configured to acquire a trained learning model;
a first selection unit configured to select an image transformation method executed on an image by using the acquired learning model; and
a second selection unit configured to select an image used to retrain the learning model by using the selected image transformation method and the acquired learning model.

2. The information processing apparatus according to claim 1, wherein execution of the stored program further configures the first selection unit to calculate a score for an individual image transformation method candidate by using an annotated image including an annotation representing ground truth information and the acquired learning model, and selects an image transformation method based on the score.

3. The information processing apparatus according to claim 2,
wherein execution of the stored program further configures the first selection unit to operate as a first calculation unit that provides, as input to the acquired learning model, a transformed image of the annotated image, the transformed image having been obtained by executing image transformation based on an image transformation method candidate and calculates an uncertainty of an output result obtained by the acquired learning model, and
a second calculation unit that calculates the score for an individual image transformation method candidate based on an uncertainty calculated by the first calculation unit.

4. The information processing apparatus according to claim 3, wherein the first calculation unit calculates the uncertainty by comparing the output result and the ground truth information.

5. The information processing apparatus according to claim 2, wherein the first selection unit selects an image transformation method whose score is high or is equal to or more than a threshold.

6. The information processing apparatus according to claim 1, wherein execution of the stored program further configures the second selection unit to select an image from unannotated images having no ground truth information added, and use the selected unannotated image an annotation addition target.

7. The information processing apparatus according to claim 6,
wherein execution of the stored program further configures the second selection unit to include a third calculation unit that provides, as an input to the acquired learning model, a transformed image of the unannotated image, the transformed image having been obtained by executing image transformation based on a selected image transformation method and calculates an uncertainty of an output result obtained by the learning model, and
wherein the second selection unit includes a fourth calculation unit that calculates a priority of the unannotated image based on the calculated uncertainty.

8. The information processing apparatus according to claim 1, wherein the learning model is used to execute a task including at least one of image classification, object detection, and segmentation.

9. The information processing apparatus according to claim 3, wherein in a case where the output result includes a classification result, the first calculation unit calculates the uncertainty based on a probability distribution distance between a probability distribution obtained from the ground truth information and the classification result transformed into a probability distribution.

10. The information processing apparatus according to claim 3, wherein in a case where the output result includes location information or area information, the first calculation unit calculates the uncertainty based on a degree of overlapping between a location or an area obtained from the ground truth information and a location or an area included in the output result.

11. The information processing apparatus according to claim 3, wherein in a case where the output result includes both a classification result and location or area information, the second calculation unit calculates the score based on a combination of the uncertainty calculated based on the classification result and the uncertainty calculated based on the location or area or based on one of the uncertainties.

12. The information processing apparatus according to claim 1, wherein execution of the stored program further configures the first selection unit to select an image transformation method from candidates including at least one of geometrical transformation, color tone transformation, noise addition, blurring, and mosaic.

13. The information processing apparatus according to claim 1, wherein execution of the stored program further configures the at least one processor to operate as an update that updates the acquired learning model by retraining the acquired learning model using the selected image,
wherein the acquisition unit acquires the updated learning model.

14. An information processing apparatus that executes active learning by repeating image selection and retraining of a learning model with the selected images, the information processing apparatus comprising:
at least one memory storing a program; and
at least one processor that, upon execution of the program is configured to operate as:
a setting unit configured to set an image transformation method for an image;
an acquisition unit configured to acquire a trained learning model; and
a selection unit configured to select an image used to retrain the learning model by using the set image transformation method and the acquired learning model,
wherein the setting unit changes a currently set image transformation method, depending on progress of training of the learning model acquired by the acquisition unit.

15. An information processing method that executes active learning by repeating image selection and retraining of a learning model with the selected images, the information processing method comprising:
acquiring a trained learning model;
executing first selection for selecting an image transformation method executed on an image by using the acquired learning model; and
executing second selection for selecting an image used to retrain the learning model by using the selected image transformation method and the acquired learning model.

16. A non-transitory computer readable storage medium that stores a program causing a computer of an information processing apparatus that executes active learning by repeating image selection and retraining of a learning model with the selected images to function as:
an acquisition unit configured to acquire a trained learning model;
a first selection unit configured to select an image transformation method executed on an image by using the acquired learning model; and
a second selection unit configured to select an image used to retrain the learning model by using the selected image transformation method and the acquired learning model.
